(19) United States
(12) Patent Application Publication
(10) Pub. No.: US 2020/0132028 A1
(43) Pub. Date: Apr. 30, 2020

(54) VALVE DRIVE FOR AT LEAST ONE POPPET VALVE OF AN INTERNAL COMBUSTION ENGINE

(71) Applicant: MAN Truck & Bus SE, Munchen (DE)

(72) Inventors: Sebastian Müller, Fürth (DE); Peter Bogdanski, Schwabach (DE)

(21) Appl. No.: 16/664,762

(22) Filed: Oct. 25, 2019

(30) Foreign Application Priority Data
Oct. 26, 2018 (DE) 10 2018 126 757.6

(51) Int. Cl. F02M 55/02; F02M 63/02

(52) U.S. Cl. CPC F02M 55/025; F02M 55/005; F02M 63/0225

(57) ABSTRACT

The present disclosure relates to a valve drive for at least one poppet valve of an internal combustion engine. The present disclosure further relates to an internal combustion engine and a motor vehicle having such a valve drive. The valve drive includes a valve lever for actuating the at least one poppet valve; and a valve lever axle on which the valve lever is mounted in a pivotably movable manner. The valve drive is characterized in that a fuel distributor for receiving pressurized fuel, that is to say, a rail, is integrated in the valve lever axle.

### BACKGROUND

The present disclosure relates to a valve drive for at least one poppet valve of an internal combustion engine. The present disclosure further relates to an internal combustion engine and a motor vehicle having such a valve drive.

So-called common rail systems which are also referred to as storage injection systems are known from the prior art. The term common rail relates in this instance to a high-pressure distributor for the fuel. The pressure generation and the fuel injection are decoupled from each other in the common rail system. A separate high-pressure pump continuously produces pressure. This pressure which is produced independently of the injection sequence is available in the fuel line permanently. To this end, the statically compressed fuel is stored in a distributor pipe, the so-called rail, and made available to the injectors of a cylinder bank in a state distributed over pressure lines.

This rail is fixed to the cylinder head as a separate component, usually at the outer side. Consequently, corresponding structural space is required for this. In particular in drive units in which not only one rail but also a second rail or a plurality of rails are required, there is posed the question of how they can be arranged in a manner as space-saving as possible.

### SUMMARY

An object of the present disclosure is to provide an improved rail or an improved fuel distributor for receiving pressurized fuel, by means of which disadvantages of conventional rails can be prevented. The object of the present disclosure is in particular to allow a way of distributing fuel which takes up less structural space.

These objects are achieved by a valve drive having the features of the independent claim. The dependent claims relate to advantageous embodiments and applications of the present disclosure and are explained in greater detail in the following description with partial reference to the Figures.

According to a general viewpoint of the present disclosure, the objects mentioned are achieved in that a fuel distributor for receiving pressurized fuel, in this instance also referred to as the rail of the fuel supply, is integrated into a valve lever axle of a valve drive.

Accordingly, a valve drive for at least one poppet valve, in some embodiments for actuating at least one load changing valve of an internal combustion engine, is provided and comprises a valve lever for actuating the at least one poppet valve and a valve lever axle on which the valve lever is mounted in a pivotably movable manner. According to the present disclosure a fuel distributor for receiving pressurized fuel is integrated in the valve lever axle. In other words, at least one fuel distributor for receiving pressurized fuel, that is to say, at least one rail of the common rail system, extends at least partially inside the valve lever axle.

According to an advantageous embodiment, the valve lever axle for forming the fuel distributor may have a hollow space for receiving pressurized fuel, in some embodiments an axially extending hollow space. This hollow space may have a pressure pipe which extends inside the valve lever axle for receiving pressurized fuel.

Consequently, the axle of the valve drive is constructed in such a manner that it can act as a rail. The valve drive thereby performs a dual function, that is to say, it serves to support the valve lever and acts as a fuel distributor, for example, as a pressure pipe, for a fuel medium. Or, in other words, a fuel distributor which at the same time performs a bearing function of the valve drive is provided. The integration of a plurality of functions in such a component is thereby particularly space-saving or at least neutral in terms of structural space if an additional rail, for example, a second rail, is thereby intended to be provided. A conventional rail can thereby be saved as a separate component, which further allows a reduction in costs. An additional advantage further involves the high-pressure lines, which are shorter in comparison with a conventional fuel distributor, to the injector if the fuel distributor is integrated directly in the valve lever axle. A particular advantage thereof is that less pressure pulsing is thereby produced and less pressure-loaded material is present, whereby the costs for these components become lower. The resultant arrangement further affords the possibility of configuring the pressure lines as common components. Furthermore, the present disclosure ensures a lower number of components and avoids passage through the charge air collector with specific drive unit configurations. As a result of the circumstance that most rocker lever axles have a substantially greater outer diameter than conventional rails, cost-intensive subsequent processing operations, such as autofrettage, could be avoided. If the rocker lever axle is configured as a separate axle, however, autofrettage is still possible.

Furthermore, the fuel distributor may have connections for high-pressure lines and/or may be connected to at least one fuel pressure line.

According to an embodiment, the fuel distributor may have branch connections, to which a pressure line which is connected in fluid terms to an injector of the internal combustion engine can be connected and/or is connected. Such branch connections may, for example, be configured as branch holes which each have a sealing seat and to which a branch line is connected and/or can be connected.

According to a construction variant, the branch connections can be arranged at an outer side of the valve lever axle. In this instance, it is particularly advantageous if they are arranged at a side of the valve lever axle which faces an injector of the internal combustion engine in order to allow a fuel supply which is as short as possible. It is further possible for the branch connections to comprise a welding socket in order to fix them securely.

The valve lever may be constructed as a rocker lever or as a drag lever.

According to another particular embodiment, the valve lever axle may have a lubrication oil hole for receiving lubrication oil. Consequently, the valve lever axle may have both a lubrication oil hole and the fuel distributor.

According to a possible embodiment thereof, the fuel distributor may have an axially extending portion and the lubrication oil hole may extend at least partially in an axial direction of the valve lever axle and be separated from the fuel distributor in fluid terms.

According to another aspect of the present disclosure, an internal combustion engine, in particular a diesel engine, is provided, comprising a valve drive, as described in this document, that is to say, with an integrated rail. The internal combustion engine further comprises a fuel supply system for supplying fuel to injectors of the internal combustion engine, wherein a fuel distributor for receiving pressurized fuel of the fuel system is at least partially integrated in the valve lever axle of the valve drive.

In this case, the injector of the internal combustion engine can be constructed as a so-called top feed injector and/or also as a side feed injector. According to another aspect, the valve lever axle and the fuel distributor integrated therein can be arranged under a cylinder head cover of the internal combustion engine.

The present disclosure further comprises a motor vehicle, in particular a utility vehicle, such as, for example, a lorry or bus, having a valve drive and/or an internal combustion engine as described in this document.

The above-described embodiments and features of the present disclosure can be combined with each other freely. Additional details and advantages of the present disclosure are described below with reference to the appended drawings, in which:

### BRIEF DESCRIPTION OF THE DRAWINGS

FIG. 1 is a perspective plan view of a valve drive of an internal combustion engine having top feed injectors according to an embodiment of the present disclosure; and

FIG. 2 is a cross-section of the view from FIG. 1.

### DETAILED DESCRIPTION

Identical or equivalent elements are indicated in all the Figures with the same reference numerals and some of them are not described separately.

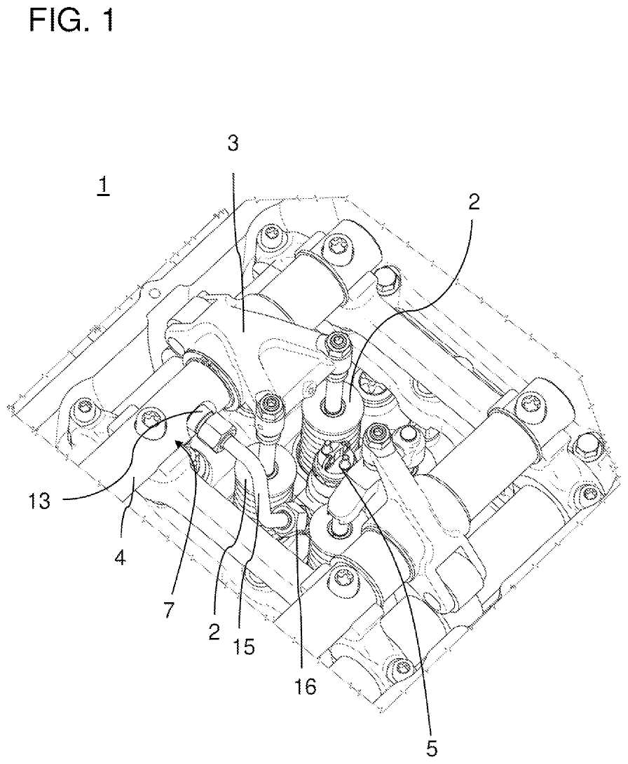

FIG. 1 is a perspective plan view of a valve drive of an internal combustion engine having top feed injectors according to an embodiment of the present disclosure. The valve drive 1 serves to actuate two poppet valves 2 of a diesel engine of a utility vehicle. To this end, the valve lever 3 has, for actuating the poppet valves 2, a valve lever axle 4, on which the valve lever 3 is mounted in a pivotably movable manner. The valve lever is configured as a toggle lever in this instance by way of example. A configuration as a drag lever is also possible, however.

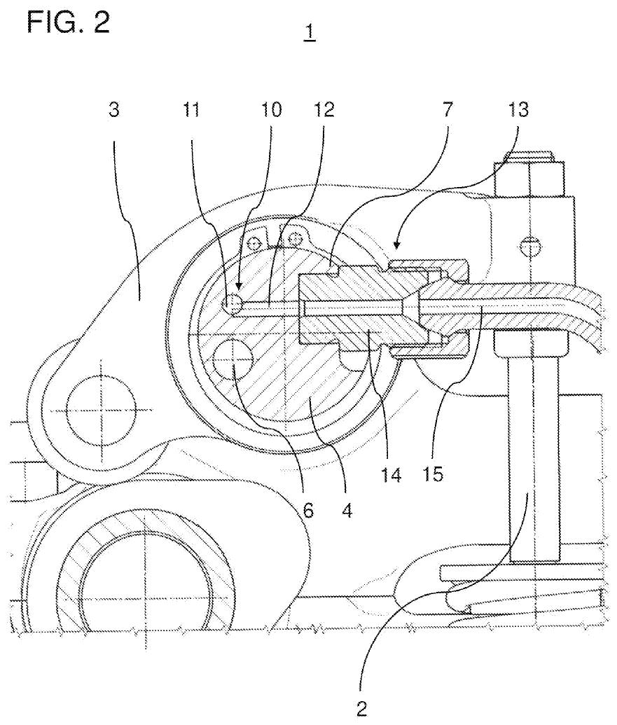

A rail or a fuel distributor 10 for receiving pressurized fuel is integrated in the valve lever axle 4. This can be readily seen in the cross-section of FIG. 2. To this end, the valve lever axle 4 has, for forming the fuel distributor 10, an axially extending hollow space 11 for receiving pressurized fuel. This hollow space forms a pressure pipe which extends inside the valve lever axle for receiving pressurized fuel. Furthermore, the fuel distributor 10 has connections 13 for high-pressure lines and is connected to a fuel pressure line.

In order to supply the top feed injectors 5, the fuel distributor has branch connections 13 which can be formed, for example, by holes which each have a sealing seat for sealing. A pressure line 15 which is connected in fluid terms to an injector 5 of the internal combustion engine is connected to these branch connections 13. The pressure line is connected to the fuel line connection 16 to the injector.

So that the pressure lines 15 are as short as possible, whereby fuel pulses can be prevented or at least reduced and structural space can be saved, the branch connections 13 are arranged at an outer side 7 of the valve lever axle at a side of the valve lever axle facing the injectors 5 of the internal combustion engine. The branch connections 13 further comprise a welding socket 14.

As can further be seen in FIG. 2, the valve lever axle further has a lubrication oil hole 6 for receiving lubrication oil. In this case, the fuel distributor 10 and the lubrication oil hole 6 each have an axially extending portion, wherein the lubrication oil hole 6 and the fuel distributor 10 are arranged so as to be offset relative to each other in the radial direction of the valve lever and are not connected to each other in fluid terms.

The fuel distributor 10 integrated in the valve lever axle in this manner can advantageously also be arranged under a cylinder head cover of the internal combustion engine.

In summary, consequently, there is provided a valve drive whose valve lever axle is configured in such a manner that it can function as a rail. The valve drive thereby performs a dual function, that is to say, it serves to support the valve lever and acts as a fuel distributor, for example, as a pressure pipe for a fuel medium. The integration of a plurality of functions in one valve drive thereby allows an arrangement of the valve drive and components of the common rail system which is particularly efficient in terms of structural space.

A conventional rail as a separate component can be saved. It may be emphasised again that an additional advantage further involves the high-pressure lines to the injector which are shorter in comparison with a conventional fuel distributor because the fuel distributor extends closer to the injectors. Fewer pressure pulses are thereby produced and the material is loaded with pressure to a lesser extent, whereby the costs for these components become lower.

As a result of the circumstance that most rocker lever axles have a substantially greater outer diameter than conventional rails, cost-intensive subsequent processing operations, such as autofrettage, could be avoided. If the rocker lever axle is configured as a separate axle, however, autofrettage is still possible.

Although the present disclosure has been described with reference to specific embodiments, it is evident for the person skilled in the art that different modifications can be carried out and equivalents can be used as replacements without departing from the scope of the present disclosure. Consequently, the present disclosure is not intended to be limited to the embodiments disclosed but instead is intended to include all the embodiments which are within the scope of the appended patent claims. In particular, the present disclosure also claims protection for the subject-matter and the features of the dependent claims irrespective of the claims referred to.

### LIST OF REFERENCE NUMERALS

1 Valve drive
2 Poppet valve, for example, load changing valve
3 Valve lever, for example, rocker lever
4 Valve lever axle
5 Top feed injector
6 Lubrication oil hole
7 Outer side of the valve lever axle
10 Fuel distributor
11 Axially extending hollow space of the fuel distributor
12 Branch line
13 Branch connection
14 Welding socket
15 Fuel line
16 Fuel line connection

What is claimed is:

1. A valve drive for at least one poppet valve for actuating at least one load changing valve of an internal combustion engine, comprising:
a valve lever for actuating the at least one poppet valve;
a valve lever axle on which the valve lever is mounted in a pivotably movable manner, wherein a fuel distributor for receiving pressurized fuel is integrated in the valve lever axle.

2. The valve drive according to claim 1, wherein the valve lever axle for forming the fuel distributor has a) a hollow space for receiving pressurized fuel, and b) a pressure pipe which extends inside the valve lever axle for receiving pressurized fuel.

3. The valve drive according to claim 1, wherein the fuel distributor has connections for high-pressure lines or is connected to at least one fuel pressure line.

4. The valve drive according to claim 1, wherein the fuel distributor has branch connections including branch holes which each have a sealing seat and to which a pressure line which is connected in fluid terms to an injector of the internal combustion engine can be connected or is connected.

5. The valve drive according to claim 4, wherein the branch connections are arranged at an outer side of the valve lever axle.

6. The valve drive according to claim 4, wherein the branch connections are arranged at a side of the valve lever axle which faces an injector of the internal combustion engine.

7. The valve drive according to claim 4, wherein the branch connections comprise a welding socket.

8. The valve drive according to claim 1, wherein the valve lever is a rocker lever or a drag lever.

9. The valve drive according to claim 1, wherein the valve lever axle has a lubrication oil hole for receiving lubrication oil.

10. The valve drive according to claim 9, wherein the fuel distributor has an axially extending portion and the lubrication oil hole extends at least partially in an axial direction of the valve lever axle and is separated from the fuel distributor in fluid terms.

11. An internal combustion engine comprising:
a valve drive according to claim 1, and
a fuel supply system for supplying fuel to injectors of the internal combustion engine, wherein a fuel distributor for receiving pressurized fuel of the fuel system is at least partially integrated in the valve lever axle of the valve drive.

12. The internal combustion engine according to claim 11, wherein the injector is constructed as a so-called top feed injector or side feed injector.

13. The internal combustion engine according to claim 11, wherein the valve lever axle and the fuel distributor integrated therein are arranged under a cylinder head cover of the internal combustion engine.

14. The internal combustion engine according to claim 11, wherein the internal combustion engine is a diesel engine.

15. A motor vehicle having a valve drive according to claim 1.

16. The motor vehicle of claim 15, wherein the motor vehicle is a utility vehicle selected from a lorry or a bus.

17. A motor vehicle having an internal combustion engine according to claim 11.

18. The motor vehicle of claim 17, wherein the motor vehicle is a utility vehicle selected from a lorry or a bus.
